(19) United States
(12) Patent Application Publication
(10) Pub. No.: US 2008/0035735 A1
(43) Pub. Date: Feb. 14, 2008

(54) Identification device

(75) Inventors: Jian-Shian Lin, Yilan County (TW); Chih-Chieh Su, Taichung County (TW); Hsiu-Chen Hsu, Tainan City (TW); Lai-Sheng Chen, Hsinchu City (TW); Jen-Hui Tsai, Hsinchu City (TW); Lih-Huey Lai, Taipei City (TW)

Correspondence Address: BIRCH STEWART KOLASCH & BIRCH, PO BOX 747, FALLS CHURCH, VA, 22040-0747, US

(73) Assignee: Industrial Technology Research Institute

(21) Appl. No.: 11/594,811

(22) Filed: Nov. 9, 2006

(30) Foreign Application Priority Data
Aug. 11, 2006 (TW) 095129465

(51) Int. Cl. G06K 19/00; G06K 5/00; G06K 19/06

(52) U.S. Cl. 235/487; 235/491; 235/380

(57) ABSTRACT

The identification device disclosed in the present invention is comprised of: a carrier; and a plurality of pseudo-pixels; wherein each of the plural pseudo-pixels is formed on the carrier and is further comprised of at least a light grating composed of a plurality of light grids. In a preferred aspect, each of the plural light grids is formed on the carrier while spacing from each other by a pitch ranged between 50nm and 900nm. As the aforesaid identification device can present specific colors and patterns while it is being viewed by naked eye with respect to a specific viewing angle, the identification device is preferred for security and anti-counterfeit applications since the specific colors and patterns will become invisible when it is viewed while deviating from the specific viewing angle.

### FIELD OF THE INVENTION

The present invention relates to an identification device, and more particularly, to an array of pseudo-pixels, each being made up of at least a light grating capable of representing a specific color while being viewed with respect to a specific viewing angle, by which a specific pattern and color can be detected by naked eye as it is viewed from the specific viewing angle so as to devise an apparatus for verifying all kinds of counterfeit or pirated goods.

### BACKGROUND OF THE INVENTION

It has been said that there are various kinds of counterfeit or pirated goods being sold in the world. The goods ranges from handbags, watches under several well-known brands, CD, DVD, parts of cars and motorcycles to pharmaceutical products and diet supplement. These counterfeit and pirated goods not only impede the technology and economic developments and creation activities, but also threaten safety in daily lives of people as the qualities of counterfeits are not comparable to those of the well-known brands. In order to cope with these counterfeit and pirated goods, campaign to eradicate counterfeit and pirated goods by devising a verifiable authenticating element for enabling users to identify a genuine good from a counterfeit would be an important policy.

In recent years, a kind of laser holographic method for anti-counterfeit identification mark has been developed, which can be formed on a tag to be attached to a product or can be formed directly on the surface of the product. However, as the laser holographic mark has an appearance which changes with the viewing angle and/or the angle of illumination changes, the glaring of the laser holographic mark do impede the verifiable authenticating element from identifiable.

One other anti-counterfeit identification technique is disclosed in U.S. Pat. No. 5,912,767, entitled “Diffractive indicia for a surface”, which is substantially a foil having a plurality of small separate diffractive elements formed thereon and arranged as an array while the foil is applicable to the surface. By the various arrangements of the array, the appearance of the diffractive indicia changes when the viewing angle and/or angle of illumination changes and thus the diffractive indicia is suitable to be used as an anti-counterfeit identification means. However, it has shortcomings listed as following: (1) the foil can be easily damaged by scratch, moreover, it is easy to become warped or even falling off the surface as the adhesive of the foil to the surface is wearing off; (2) the array of various diffractive elements is difficult to manufactured; (3) the color change of the aforesaid diffractive indicia is barely recognizable by naked eye that impedes the verifiable authenticating element from identifiable.

Yet, another anti-counterfeit identification technique is disclosed in U.S. Pat. No. 6,062,604, entitled “Self-verifying security document”, wherein the self-verifying security document, such as a banknote, comprises a flexible sheet formed from a plastics substrate bearing indicia. The sheet has a window of transparent plastics material which includes self-verification means for verifying a security device provided at a laterally spaced second portion of the sheet when the sheet is bent or folded to bring the window into register with the security device. However, the aforesaid self-verifying security document can only be applicable to flexible document, such as a banknote, and is not applicable to rigid substrate such as a credit card that the application thereof is limited.

Therefore, it is in need of an identification device that not only is an improve over the aforesaid anti-counterfeit identification devices, but also is an apparatus capable of verifying all kinds of counterfeit or pirated goods with preferred identification effect.

### SUMMARY OF THE INVENTION

In view of the disadvantages of prior art, the primary object of the present invention is to provide an identification device having an array of a plurality of pseudo-pixels, each being made up of at least a light grating, by which a specific pattern can be achieved by the arrangement of the plural pseudo-pixels in the array.

It is another object of the invention to provide an identification device having an array of a plurality of pseudo-pixels, each being made up of at least a light grating, by which a specific pattern can be achieved by the arrangement of the plural pseudo-pixels in the array while enabling the specific pattern to be visible as it is being viewed by naked eye with respect to a specific viewing angle and becoming invisible while deviating from the specific viewing angle, and thus enabling the identification device for various of applications with preferred identification effect.

To achieve the above objects, the present invention provides an identification device, comprising a carrier; and a plurality of pseudo-pixels; wherein each of the plural pseudo-pixels is formed on the carrier and is further comprised of at least a light grating composed of a plurality of light grids while enabling each of the plural light grids to be spaced from each other by a pitch ranged between 50 nm and 900 nm.

In a preferred embodiment of the invention, the carrier is made of a transparent material, preferably selected from the group consisting of a glass substrate and a thermoplastic material.

Preferably, the profile of a section of each light grid is defined by a function selected from the group consisting of a curve, a polygon and the combination thereof, wherein, the curve can be an arc; and the polygon can be a triangle, a quadrangle or a pentagon.

Preferably, each light grating has an orientation for structuring the light grids thereof.

Preferably, at least one light grid orientation is structured in the plural pseudo-pixels.

Preferably, the period for aligning the light grids is a period selected from a single-period and a multi-period.

Preferably, the period for aligning the at least one light grating is a period selected from a single-period and a multi-period.

Preferably, the period for aligning the plural pseudo-pixels is a period selected from a single-period and a multi-period.

Preferably, the plural pseudo-pixels are arranged as a matrix.

Preferably, each light grating is a grating selected from the group consisting of a straight line grating, a curved line grating, a deflected line grating.

In addition, to achieve the above objects, the present invention provides an identification device, comprising a carrier; a plurality of first pseudo-pixels, and a plurality of second first pseudo-pixels; wherein each of the first plural pseudo-pixels is formed on the carrier and is further comprised of at least a first light grating composed of a plurality of first light grids while enabling each of the plural first light grids to be spaced from each other by a micron-scaled pitch; and each of the plural second pseudo-pixels is formed on a first pseudo-pixel corresponding thereto and is further comprised of at least a second light grating composed of a plurality of second light grids while enabling each of the plural second light grids to be spaced from each other by a pitch ranged between 50 nm and 900 nm.

Other aspects and advantages of the present invention will become apparent from the following detailed description, taken in conjunction with the accompanying drawings, illustrating by way of example the principles of the present invention.

### BRIEF DESCRIPTION OF THE DRAWINGS

FIG. 1A is a top view of a light grating according to a preferred embodiment of the invention.

FIG. 1B is a sectional view of a light grating according to a preferred embodiment of the invention.

FIG. 1C is a schematic view of light grid according to the present invention.

FIG. 2A is a schematic sectional diagram showing the profile of light grids according to the present invention.

FIG. 2B is a schematic diagram illustrating the aligning period of light grids according to the present invention.

FIG. 3A is a side view of an identification device depicting a light beam being reflected thereby whereas the incident light beam is parallel to the orientation of the light grating thereof.

FIG. 3B is a top view of an identification device depicting a light beam being reflected thereby whereas the incident light beam is parallel to the orientation of the light grating thereof.

FIG. 4A is a side view of an identification device depicting a light beam being reflected thereby whereas the incident light beam is perpendicular to the orientation of the light grating thereof.

FIG. 4B is a top view of an identification device depicting a light beam being reflected thereby whereas the incident light beam is perpendicular to the orientation of the light grating thereof.

FIG. 5 is a schematic diagram illustrating an identification device according to a preferred embodiment of the invention.

FIG. 6A and FIG. 6B are schematic diagrams showing light gratings of different orientations.

FIG. 7 shows a matrix of a plurality of pseudo-pixels, whereas a specific pattern/character is achieved by the matrix.

FIG. 8 is a schematic diagram showing an identification device of an invention, whereas the identification device is being examined by an inspection apparatus specialized for the same.

FIG. 9A is a schematic diagram illustrating an identification device according to another preferred embodiment of the invention.

FIG. 9B shows the orientations of light grids according to the present invention.

FIG. 10A and FIG. 10B are respectively a top view and a side view of an identification device according to yet another preferred embodiment of the invention.

### DESCRIPTION OF THE PREFERRED EMBODIMENT

For your esteemed members of reviewing committee to further understand and recognize the fulfilled functions and structural characteristics of the invention, several preferable embodiments cooperating with detailed description are presented as the follows.

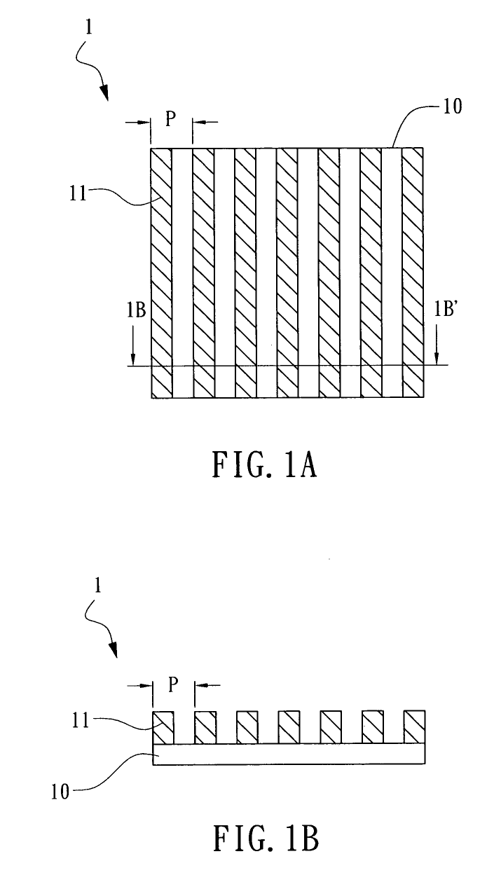

Please refer to FIG. 1A and FIG. 1B, which are respectively a top view and a sectional view of a light grating according to a preferred embodiment of the invention. The light grating 1, being formed on a carrier 10, is comprised of a plurality of light grids 11, in which each of the plural light grids 11 is formed on the carrier 10 while enabling each of the plural light grids 11 to be spaced from each other by a pitch ranged between 50 nm and 900 nm. In a preferred aspect, the carrier 10 is made of a transparent material, such as a glass substrate or a thermoplastic material, but is not limited thereby. Please refer to FIG. 1C, which is a schematic view of light grid according to the present invention. It is noted that the light grid of FIG. 1A is a straight line, however, it can be a curved line light grid 12 or a deflected line light grid 13, as those shown in FIG. 1C. Except for the straight line, the curved line and the deflected line light grids set forth for the purpose of disclosure, other modifications of the disclosed light grids are also covered by the present invention.

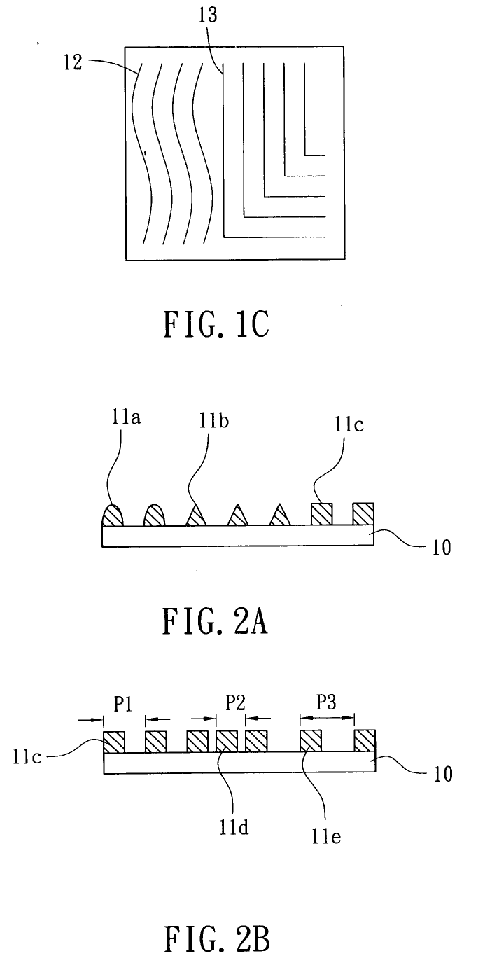

Please refer to FIG. 2A, which is a schematic sectional diagram showing the profile of light grids according to the present invention. It is noted that the profile of a section of each light grid can be defined by a function selected from the group consisting of a curve, a polygon and the combination thereof. In FIG. 2A, the curve profile is defined as an arc 11a, however, it is not limited thereby; and the polygon profile is defined as an triangle 11b, such as an isosceles triangle, a regular triangle, etc., or as a quadrangle 11c, however, it is also not limited thereby. In a preferred aspect, the period for aligning the light grids can be a single-period, however, it can also so a multi-period. Please refer to FIG. 2B, which is a schematic diagram illustrating the aligning period of light grids according to the present invention. In FIG. 2B, the light grids 11c are separated from each other by a pitch P1, the light grids 11d are separated from each other by a pitch P2; and the light grids 11e are separated from each other by a pitch P3. Thus, the light grating of FIG. 2B has three light grids of different aligning periods.

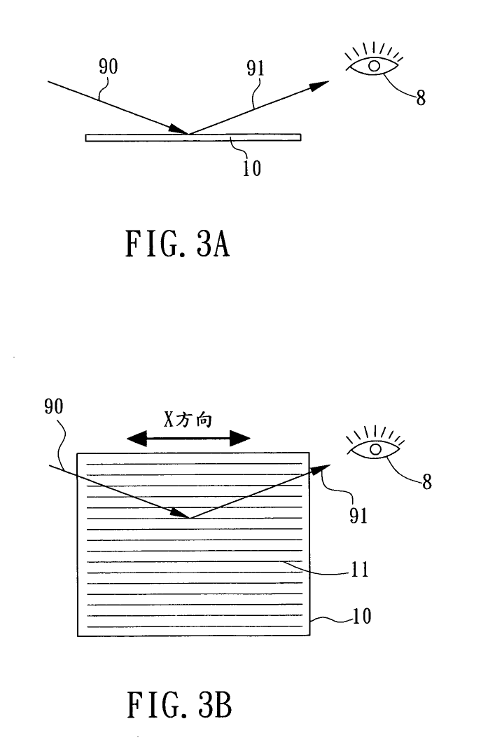

Please refer to FIG. 3A and FIG. 3B, which are respectively a side view and a top view of an identification device depicting a light beam being reflected thereby whereas the incident light beam is parallel to the orientation of the light grating thereof. As the light beam 90 shine on the light grating, the light beam 90 is not diffracted and thus there will present no color reaction since the light grating is aligned parallel to the incidence of the light beam 90. Therefore, as the reflected light 91 is received by a naked eye 8, no color can be recognized thereby.

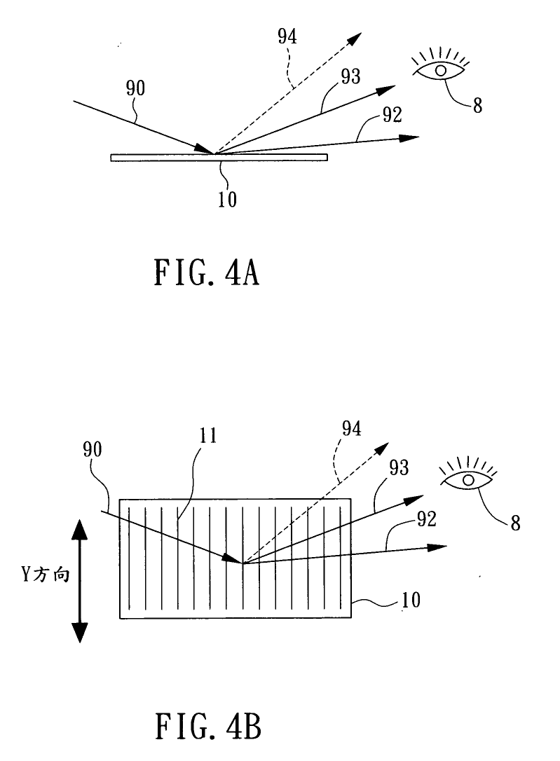

Please refer to FIG. 4A and FIG. 4B, which are respectively a side view and a top view of an identification device depicting a light beam being reflected thereby whereas the incident light beam is perpendicular to the orientation of the light grating thereof. As the light beam 90 shine on the light grating whose light grids 11 are oriented perpendicular to the incident light beam 90, the light beam 90 is diffracted in to three reflecting light beams, i.e. a first reflecting light 92, a second reflecting light 93 and a third reflecting light 94, and thus there will present a effect of color reaction. That is, as the incident light beam 90 is scattered by the perpendicularly oriented light grating, a variety of color will appear to an naked eye 8 with respect to different viewing angles.

From the above description, it is noted that, by the displacement and orientation of light grating, it is possible to use a element having light grating formed thereon as a pixel similar to that of a display unit, such that the aforesaid pixel-like element is addressed as a pseudo-pixel hereinafter. Moreover, by the combination of a plurality of such pseudo-pixels, a specific pattern can be achieved. By using each pseudo-pixel as a piece of a jigsaw puzzle which can be considered as a matrix of pseudo-pixels, any pattern conceivable is capable of being achieved.

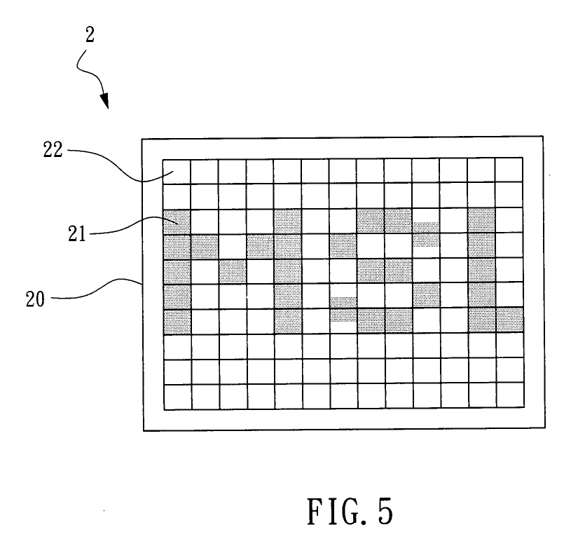

Thus, an identification device capable of revealing a set of characters “MSL” can be achieve, as that shown in FIG. 5. The identification device 2 is comprised of: a carrier 20; and a plurality of pseudo-pixels 21, 22; wherein each of the plural pseudo-pixels 21, 22 is formed on the carrier 20 and is further comprised of at least a light grating of a specific orientation, which is composed of a plurality of light grids while enabling each of the plural light grids to be spaced from each other by a pitch ranged between 50 nm and 900 nm.

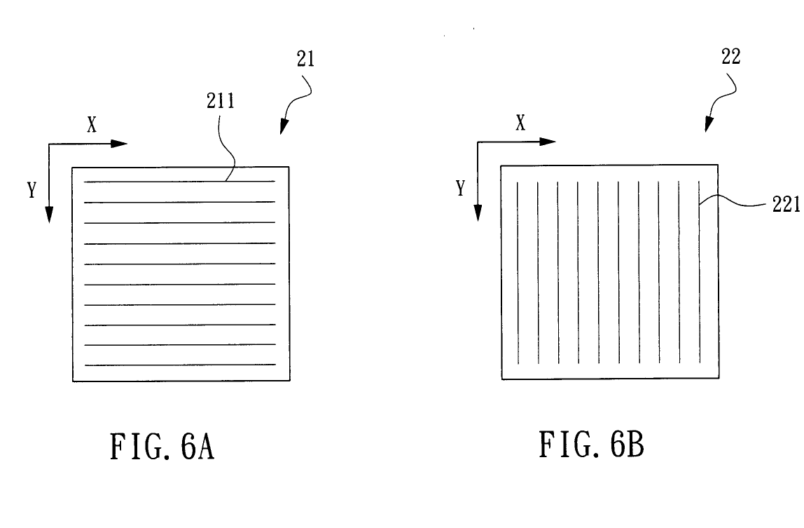

The light grids in the plural pseudo-pixels 21, 22 have at least one orientation. In the preferred embodiment shown in FIG. 5, there are two kinds of light grids of different orientations. Please refer to FIG. 6A and FIG. 6B, which are re schematic diagrams showing light gratings of different orientations. In FIG. 6A, the light grids of the light grating 211 formed in the pseudo-pixel 21 is oriented parallel to the X-direction. In FIG, 6B, the light grids of the light grating 221 formed in the pseudo-pixel 22 is oriented parallel to the Y-direction. Thus, the pseudo-pixels 21 of X-direction-oriented light grids is used for achieving the set of characters “MSL”, while the rest of the matrix is filled by the pseudo-pixels 22 of Y-direction-oriented light grids. Therefore, by the color reaction illustrated in FIG. 3A, FIG. 3B, FIG. 4A and FIG. 4B, the identification device is capable of revealing the specific color and pattern while being viewed at a specific viewing angle.

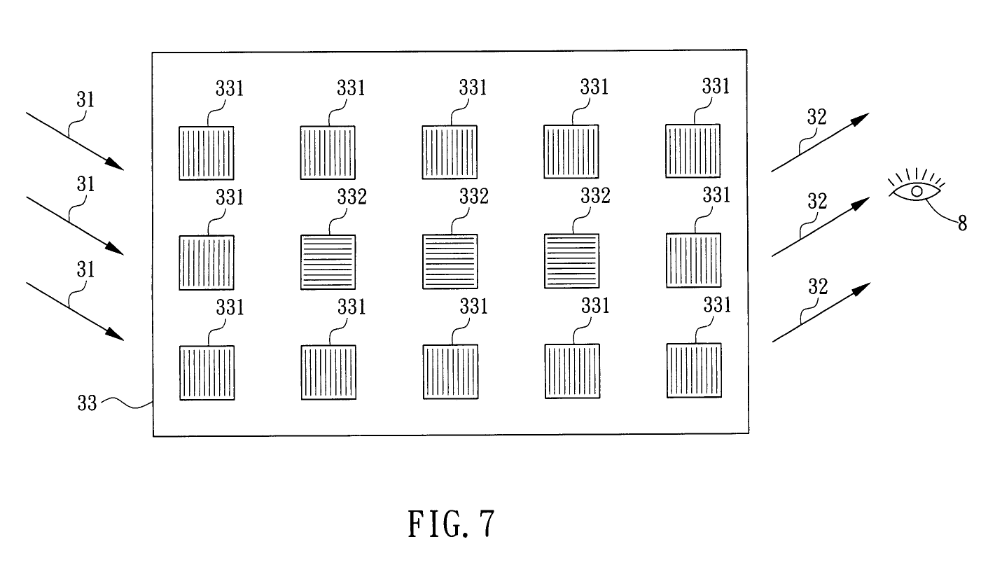

Please refer to FIG. 7, which shows a matrix of a plurality of pseudo-pixels, whereas a specific pattern/character is achieved by the matrix. As seen in FIG. 7, a plurality of pseudo-pixels is arranged on a carrier 33 in a form of a matrix while each pseudo-pixel is configured with a light grating. In the matrix, the light gratings of the pseudo-pixels 332 positioned at the second, third and fourth position on the second row of the matrix are oriented parallel to the light beams 31 shining thereon while the others 331 are oriented perpendicular thereto. Therefore, as the reflected light 32 of the matrix is received by a naked eye 8, a □-shaped pattern can be observed. Moreover, as the carrier is move up and down with respect to the longitudinal axis of the carrier 30, the color reaction of the □-shaped pattern will change accordingly as the viewing angle is changed, and thus, the matrix is considered to be capable of representing a specific pattern and specific color while being viewed at a specific viewing angle. However, the specific colors and patterns will become invisible when it is viewed while deviating from the specific viewing angle, e.g. the carrier is rotated clockwisely or counterclockwisely by 90 degrees. In this preferred embodiment, as the carrier is rotated by 90 degrees, the pattern conceivable is a “−” pattern formed by the three pseudo-pixels 332. Therefore, the identification device of FIG. 7 is preferred for security and anti-counterfeit applications.

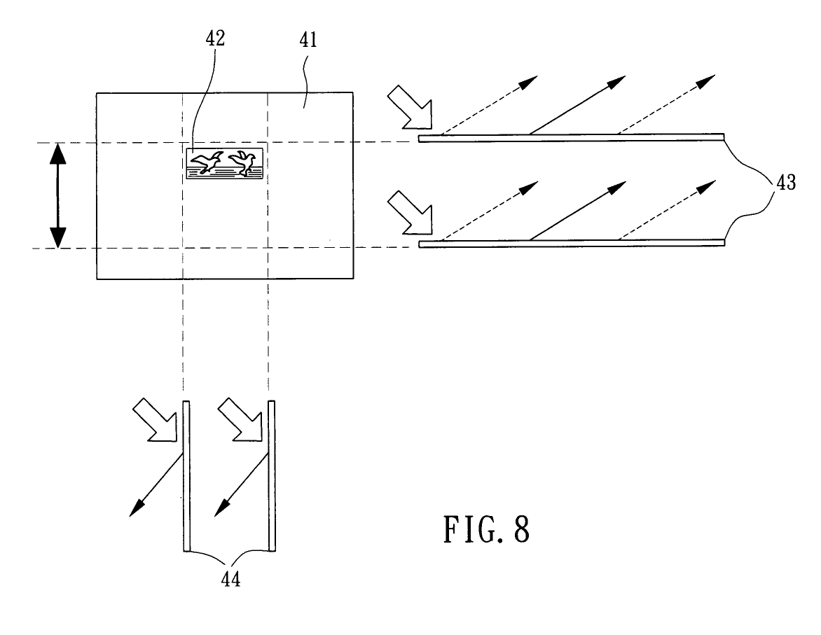

Please refer to FIG. 8, which is a schematic diagram showing an identification device of an invention, whereas the identification device is being examined by an inspection apparatus specialized for the same. In FIG. 8, the identification pattern 42 formed on the carrier 41 is an image of two birds, that is recognizable while the light gratings 43 of the identification pattern 42 is oriented perpendicular to the light beams shining thereon. Moreover, the other light gratings 44 not forming the identification pattern 42 is becoming invisible while it is oriented parallel to the light beams shining thereon. In a preferred embodiment, the aforesaid identification device structure is programmed in a computer so as to use the same for processing the structure on an object, by which the identification device can only be detected by a specific apparatus, such as a magnifier or a microscope, etc., and thus a more sophisticated security and anti-counterfeit capability can be achieved.

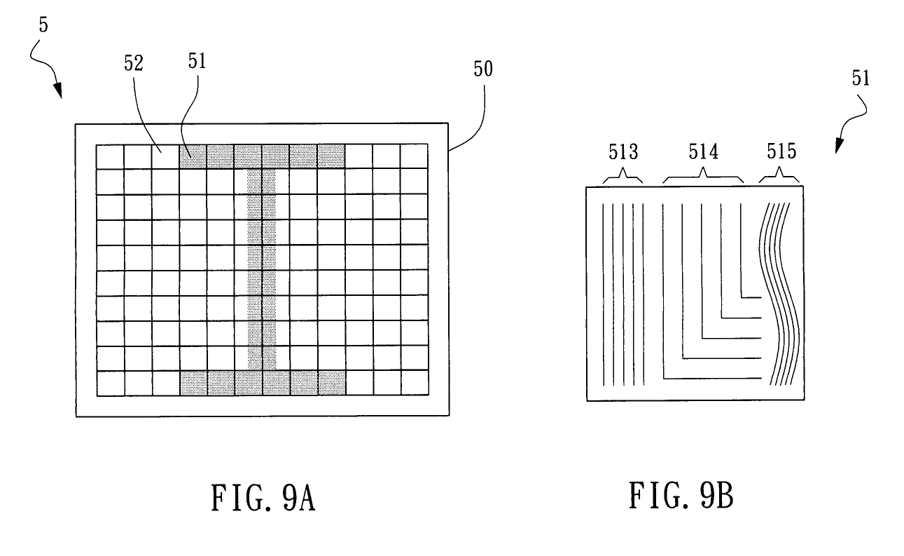

Please refer to FIG. 9A, which is a schematic diagram illustrating an identification device according to another preferred embodiment of the invention. The identification device 5 of FIG. 9A is comprised of: a carrier 50; and a plurality of pseudo-pixels 51, 52; wherein each of the plural pseudo-pixels is formed on the carrier 50 and is further comprised of at least a light grating composed of a plurality of light grids. In a preferred aspect, each light grating has at least an orientation for structuring the light grids thereof, and each of the plural light grids is formed on the carrier 50 while spacing from each other by a pitch ranged between 50 nm and 900 nm. In this preferred embodiment, an I-shaped pattern is formed by the arrangement of the plural pseudo-pixels 51, 52. Please refer to FIG. 9B, which shows the orientations of light grids according to the present invention. As seen in FIG. 9B, each of the plural pseudo-pixel 51, 52 is configured with a plurality of light grating. For instance, there are three different light gratings 510, 511, 512, being formed in one pseudo-pixel 51, in which the light grating 510 is a straight line grating, the light grating 511 is a curved line grating, and the light grating 512 is a deflected line grating. As the pitch between any two light grids is nano-scaled, the light grating is able to present various colors with respect to the angle of light shining thereon. Hence, by the arrangement of a variety of light gratings in one individual pseudo-pixel, the pseudo-pixel is enabled to present multiple colors, and thus, the identification pattern formed by such pseudo-pixel of multiple colors is more versatile.

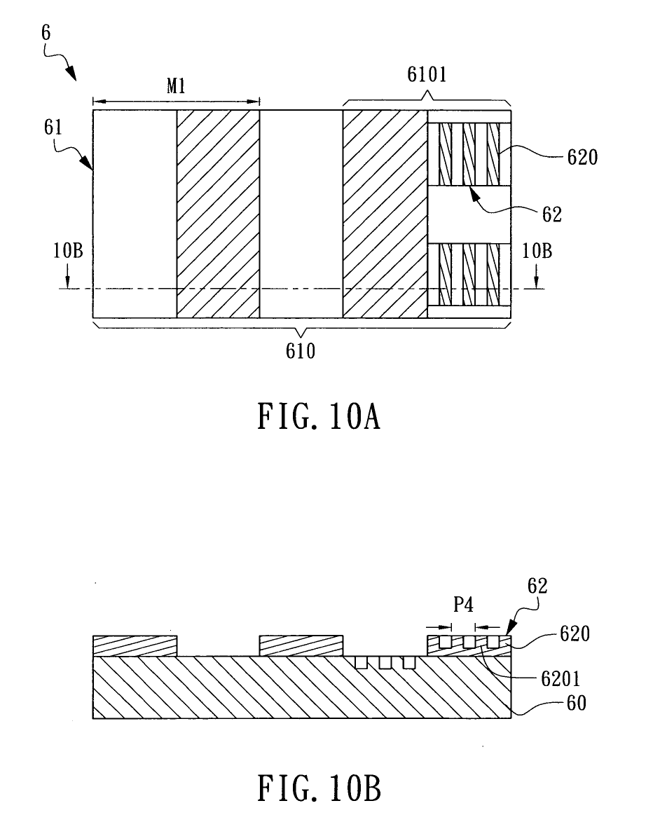

Please refer to FIG. 10A and FIG. 10B, which are respectively a top view and a side view of an identification device according to yet another preferred embodiment of the invention. As seen in FIG. 10A and FIG. 10B, the identification device is configured with light gratings of nano-scaled pitch and light grating of micron-scaled pitch. The identification device 6 of FIG. 10A is comprised of: a carrier 60; a plurality of first pseudo-pixels 61; and a plurality of second pseudo-pixels 62.

It is noted that the arrangement of the first and second pseudo-pixels 61, 62 as a matrix is similar to those stated hereinbefore. In one first pseudo-pixel 61, as that shown in FIG. 10A, it is formed on the carrier 60 and is further comprised of at least a first light grating 610 composed of a plurality of first light grids 6101 while enabling each of the plural first light grids 6101 to be spaced from each other by a micron-scaled pitch M1. Moreover, only one light grating of the first pseudo-pixel is shown in FIG. 10A and is used as illustration. In one second pseudo-pixel 62, as that shown in FIG. 10A, it is further comprised of at least a second light grating 620 composed of a plurality of second light grids 6201 while enabling each of the plural light grids 6201 to be spaced from each other by a pitch P4 ranged between 50 nm and 900 nm. Moreover, only two light grating of the second pseudo-pixel is shown in FIG. 10A and is used as illustration, and each second pseudo-pixel 62 can be formed on a portion of one first pseudo-pixel superimposing a part of the first light grids 6101 of the first light grating 610, or it can be formed on one first pseudo-pixel superimposing the whole of the first light grids 6101 of the first light grating 610. As for the combination and arrangement of the first and the second pseudo-pixels are similar to those stated hereinbefore, and thus is not described further herein. In addition, the aligning and structure of the first and second light grids are also similar to those stated hereinbefore, and thus is not described further herein.

In order to form light grids of specific pattern on a carrier, first, the pattern is programmed by the use of a computer whereas the pattern is composed of parallel-oriented light grids and perpendicular-oriented light grids, and then the pattern in printed on a mold by electron-beam lithography. As the carrier is made of non-metal material, that is preferred to be made of a glass substrate or a thermoplastic material since both the glass substrate and thermoplastic material are transparent for enabling the light shining thereon to present various color reaction by diffraction and reflection, a thermoforming process or an UV curing process can be used to form light grids on the surface of the carrier by the use of the aforesaid mold. In the UV curing process, an identification device of the invention can be achieved by coating a paste on a mold of a specific pattern that is later cured by the illumination of UV light, and thus the cured molded paste is the identification device. The thermoforming process can be divided into two methods, i.e. hot embossing and hot roller imprinting. The mold of a hot embossing method is a flat plate, by which a heated carrier can be stamped to form an identification device. The mold of a hot roller imprint is a roller, by that identification devices can be formed by rolling and pressing the roller on a heated carrier.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

1. An identification device, comprising:
a carrier; and
a plurality of pseudo-pixels;
wherein, each of the plural pseudo-pixels is formed on the carrier and is further comprised of at least a light grating composed of a plurality of light grids while enabling each of the plural light grids to be spaced from each other by a pitch ranged between 50 nm and 900 nm.

2. The identification device of claim 1, wherein each light grating has an orientation for structuring the light grids thereof while there is at least one light grid orientation being structured in the plural pseudo-pixels.

3. The identification device of claim 1, wherein the carrier is made of a transparent material selected from the group consisting of a glass substrate and a thermoplastic substrate.

4. The identification device of claim 1, wherein the profile of a section of each light grid is defined by a function selected from the group consisting of a curve, a polygon and the combination thereof.

5. The identification device of claim 1, wherein the period for aligning the light grids is a period selected from a single-period and a multi-period.

6. The identification device of claim 1, wherein the period for aligning the at least one light grating is a period selected from a single-period and a multi-period.

7. The identification device of claim 1, wherein the period for aligning the plural pseudo-pixels is a period selected from a single-period and a multi-period.

8. The identification device of claim 1, wherein the plural pseudo-pixels are arranged as a matrix.

9. The identification device of claim 1, wherein each light grating is a grating selected from the group consisting of a straight line grating, a curved line grating, a deflected line grating.

10. An identification device, comprising:
a carrier;
a plurality of first pseudo-pixels, and
a plurality of second first pseudo-pixels;
wherein, each of the first plural pseudo-pixels is formed on the carrier and is further comprised of at least a first light grating composed of a plurality of first light grids while enabling each of the plural first light grids to be spaced from each other by a micron-scaled pitch; and each of the plural second pseudo-pixels is formed on a first pseudo-pixel corresponding thereto and is further comprised of at least a second light grating composed of a plurality of second light grids while enabling each of the plural second light grids to be spaced from each other by a pitch ranged between 50 nm and 900 nm.

11. The identification device of claim 10, wherein each first light grating has an orientation for structuring the light grids thereof while there is at least one light grid orientation being structured in the plural first pseudo-pixels.

12. The identification device of claim 11, wherein each second light grating has an orientation for structuring the light grids thereof while there is at least one light grid orientation being structured in the plural second pseudo-pixels.

13. The identification device of claim 12, wherein the carrier is made of a transparent material selected from the group consisting of a glass substrate and a thermoplastic substrate.

14. The identification device of claim 12, wherein the profile of a section of any one of the first and second light grids is defined by a function selected from the group consisting of a curve, a polygon and the combination thereof.

15. The identification device of claim 12, wherein the period for aligning any of the first and the second light grids is a period selected from a single-period and a multi-period.

16. The identification device of claim 12, wherein the period for aligning any of the at least one first and second light gratings is a period selected from a single-period and a multi-period.

17. The identification device of claim 12, wherein the period for aligning any of the plural first and second pseudo-pixels is a period selected from a single-period and a multi-period.

18. The identification device of claim 12, wherein the plural first pseudo-pixels are arranged as a matrix while the plural second pseudo-pixels are arranged as a matrix.

19. The identifiation device of claim 12, wherein each first light grating is a grating selected from the group consisting of a straight line grating, a curved line grating, a deflected line grating while each second light grating is a grating selected from the group consisting of a straight line grating, a curved line grating, a deflected line grating.
